(19) United States
(12) Patent Application Publication
(10) Pub. No.: US 2022/0129746 A1
(43) Pub. Date: Apr. 28, 2022

(54) DECENTRALIZED PARALLEL MIN/MAX OPTIMIZATION

(71) Applicant: International Business Machines Corporation, Armonk, NY (US)

(72) Inventors: Mingrui LIU, College Station, TX (US); Wei ZHANG, Elmsford, NY (US); Youssef MROUEH, New York, NY (US); Xiaodong CUI, Chappaqua, NY (US); Jarret ROSS, Wichita, KS (US); Payel DAS, Yorktown Heights, NY (US)

(21) Appl. No.: 17/081,779

(22) Filed: Oct. 27, 2020

(51) Int. Cl. G06N 3/08

(52) U.S. Cl. CPC G06N 3/08

(57) ABSTRACT

Techniques are provided for decentralized parallel min/max optimizations. In one embodiment, the techniques involve generating gradients based on a first set of weights associated with a first node of a neural network, exchanging the first set of weights with a second set of weights associated with a second node, generating an average weight based on the first set of weights and the second set of weights, and updating the first set of weights and the second set of weights via a decentralized parallel optimistic stochastic gradient (DPOSG) algorithm based on the gradients and the average weight.

### STATEMENT REGARDING PRIOR DISCLOSURES BY THE INVENTOR OR A JOINT INVENTOR

The following disclosure is submitted under 35 U.S.C. 102(b)(1)(A):

A Decentralized Parallel Algorithm for Training Generative Adversarial Nets by Mingrui Liu, Wei Zhang, Youssef Mroueh, Xiaodong Cui, Jerret Ross, Tianbao Yang, Payel Das, pages 1-25, submitted/published on 28 Oct. 2019, available at https://arxiv.org/abs/1910.12999.

### BACKGROUND

The present invention relates to techniques for training neural networks, and more specifically to decentralized, parallel minimum and maximum optimization techniques for training neural networks.

Gradient descent, or gradient ascent, is a common optimization technique for training a neural network by updating weights of neurons of the neural network using gradients. Gradients are vectors of partial derivatives of a loss function with respect to the weight of each neuron. A loss function is a mathematical expression that captures errors of the outputs of the neural network based on a comparison of predicted outputs of the neural network to the actual outputs. The updates to the weights of the neurons are back-propagated throughout the neural network, which can reduce the error of the next outputs of the neural network.

One issue with traditional implementations of gradient descent is the implementation of the technique over centralized networks. In centralized networks, each node or machine that calculates a gradient must send it to a central node or machine. The central node aggregates the gradients, updates weights in the neural network, and sends parameters based on the updates to the nodes that calculate the gradients. This setup causes a network traffic bottleneck at the central node, which results in sub-optimal neural network training. These issues are exacerbated when the network bandwidth is low or the network latency is high.

Another issue with traditional implementations of gradient descent is the implementation of the technique over decentralized networks. Decentralized networks can optimize convex and non-convex minimization functions, or optimize convex-concave minimizations and maximizations (min/max) problems. However, decentralized networks have not shown the ability to optimize non-convex non-concave min/max problems, such as loss functions for generative adversarial networks. Implementing gradient descent over a decentralized network often results in a local, non-equilibrium, non-optimized solution.

### SUMMARY

A method is provided according to one embodiment of the present disclosure. The method comprises generating gradients based on a first set of weights associated with a first node of a neural network; exchanging the first set of weights with a second set of weights associated with a second node; generating an average weight based on the first set of weights and the second set of weights; and updating the first set of weights and the second set of weights via a decentralized parallel optimistic stochastic gradient (DPOSG) algorithm based on the gradients and the average weight.

A system is provided according to one embodiment of the present disclosure. The system comprises a first node of a neural network; and a second node coupled to the first node, wherein the first node is configured to generate gradients based on a first set of weights associated with the first node; exchange the first set of weights with a second set of weights associated with the second node; generate an average weight based on the first set of weights and the second set of weights; and update the first set of weights and the second set of weights via a decentralized parallel optimistic stochastic gradient (DPOSG) algorithm based on the gradients and the average weight.

A computer-readable storage medium including computer program code that, when executed on one or more computer processors, performs an operation is provided according to one embodiment of the present disclosure. The operation is configured to generate gradients based on a first set of weights associated with a first node of the neural network; exchange the first set of weights with a second set of weights associated with a second node; generate an average weight based on the first set of weights and the second set of weights; and update the first set of weights and the second set of weights via a decentralized parallel optimistic stochastic gradient (DPOSG) algorithm based on the gradients and the average weight.

### BRIEF DESCRIPTION OF THE SEVERAL VIEWS OF THE DRAWINGS

FIG. 1 illustrates a generative adversarial network.

FIG. 2 illustrates a system for implementing a gradient-based decentralized, parallel algorithm, according to one embodiment.

FIG. 3 depicts a flowchart of a method for implementing a gradient-based decentralized, parallel algorithm, according to one embodiment.

FIG. 4 illustrates an iteration towards convergence on a stationary point for a non-convex, non-concave min/max function, according to one embodiment.

### DETAILED DESCRIPTION

Embodiments of the present disclosure are directed towards techniques for training decentralized neural networks using gradient-based decentralized, parallel algorithms that converge on a stationary point for non-convex, non-concave min/max problems. Convergence on the stationary point can be reached by performing multiple predetermined rounds of weight exchanges between nodes in neural networks, averaging the weights at each node during each iteration of the predetermined rounds of weight exchanges, and updating the weights at each node using gradients calculated at each respective node. Further, the present disclosure allows multiple neural networks to be updated simultaneously.

So that features of the present disclosure can be understood in detail, embodiments of the present disclosure may reference a generative adversarial network (GAN). However, the present disclosure can apply to any neural network, and should not be interpreted as being confined to GANs.

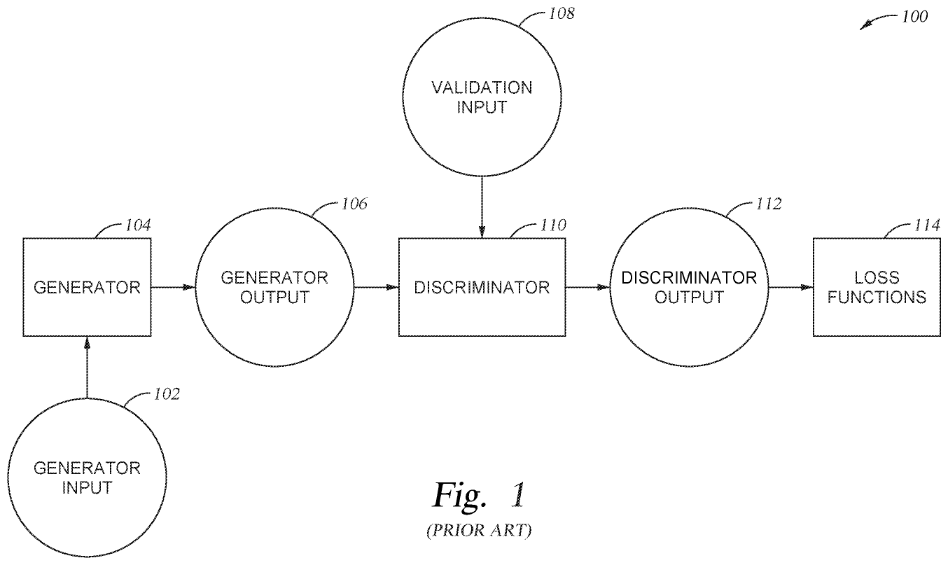

FIG. 1 illustrates a generative adversarial network. A GAN 100 is an implementation of an adaptive network comprising two competing neural networks, a generator 104 and a discriminator 110. The generator and discriminator can each include an input layer, optional hidden layers, and an output layer, where each layer includes at least one neuron. Each neuron is associated with a weight that can be updated to train the GAN.

The goal of the generator 104 is to maximize an error of the discriminator output 112. The generator 104 receives a generator input 102 from a latent space (not shown), and generates a generator output 106.

The goal of the discriminator 110 is to minimize an error of the discriminator output 112. The discriminator 110 receives a validation input 108 (e.g., training data), which is used to train the discriminator 110. In a different epoch, the discriminator 110 receives generator output 106. The discriminator 110 evaluates the generator output 106, and generates a corresponding assessment as the discriminator output 112.

For example, GANs are often implemented in image creation and recognition settings. In this setting, the generator creates an image that is sent into the discriminator. The discriminator receives, in different epochs, an image from a training set or the image from the generator. The discriminator assesses the received image to determine whether or not the image is authentic. For instance, the image is authentic if it came from the training set, or is inauthentic if it was created by the generator. By using the generator output (the image created by the generator) as the discriminator input, the two neural networks are set up with opposing goals. That is, the generator tries to get the discriminator to assess the image created by the generator as being authentic, while the discriminator tries to assess the image from the training set as being inauthentic. Therefore, the loss function of the generator attempts to maximize the error of the discriminator, while the loss function of the discriminator attempts to minimize the error of the discriminator. Hence, training the generator and discriminator involve optimizing simultaneously minimizing and maximizing the respective loss functions, or a composite min/max function.

Returning to FIG. 1, loss functions 114 for the generator 104 and discriminator 110 are generated based on the discriminator output 112. The loss function of the generator 104 represents a maximization function of the error of the discriminator output 112, while the loss function of the discriminator 110 represents a minimization function of the discriminator output 112. Therefore, the generator is in competition with the discriminator.

Typically, the generator 104 and discriminator 110 are trained using gradient descent. As previously discussed, neural networks, such as GANs, which implement gradient descent over a centralized network can have sub-optimal training due to network traffic issues related to the transfer of the gradients to a central node. Embodiments of the present disclosure can overcome these issues by transferring node-stored GAN weights (generator weights and discriminator weights) between neighboring nodes on a decentralized network and updating the weights at each node, instead of transferring gradients to and from non-central nodes and a central node. Further, embodiments of the present disclosure can guarantee convergence on a stationary point of a non-convex, non-concave min/max problem for neural networks distributed over a decentralized network.

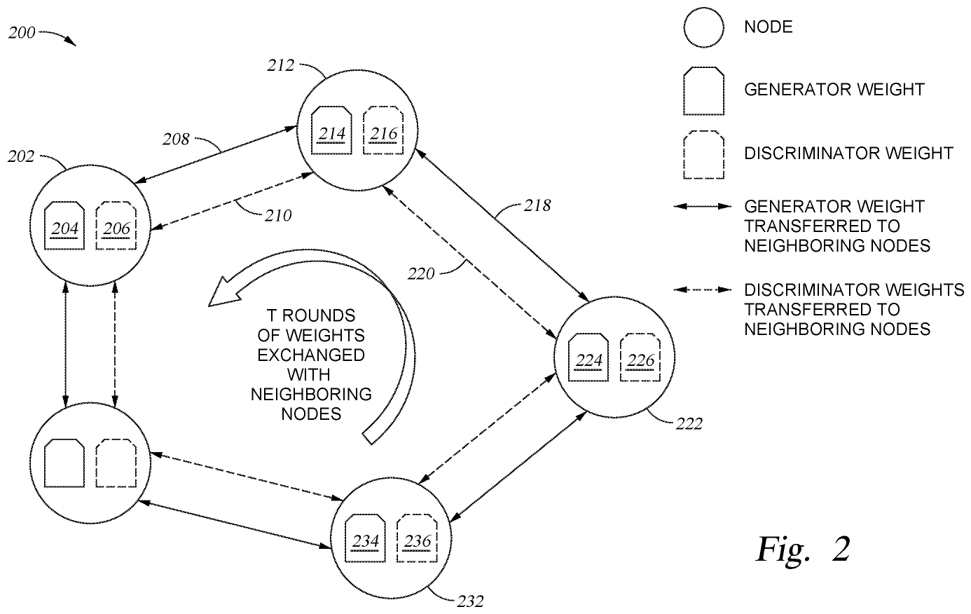

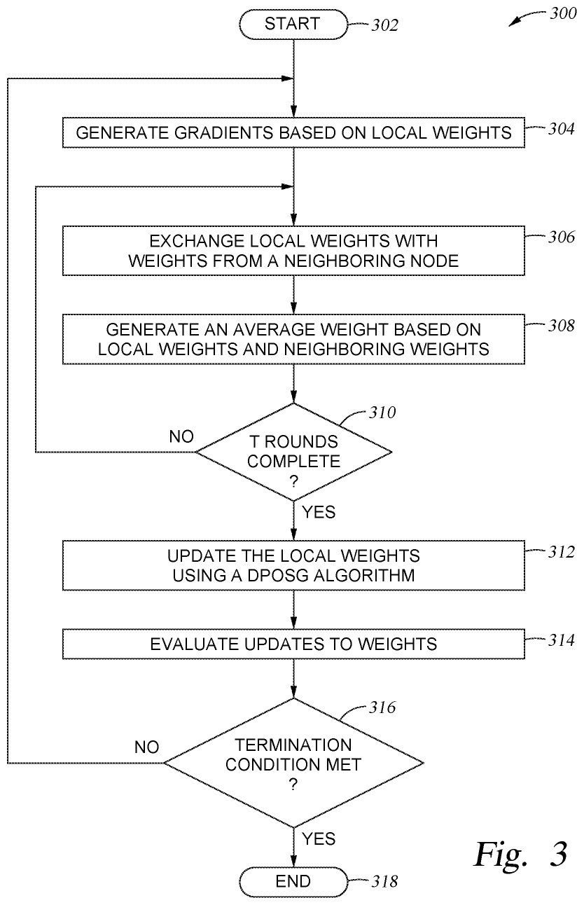

FIG. 2 illustrates a system for implementing a gradient-based decentralized, parallel algorithm, according to one embodiment. FIG. 3 depicts a flowchart of a method for implementing a gradient-based decentralized, parallel algorithm, according to one embodiment. FIG. 2 is explained in conjunction with FIG. 3.

In one embodiment, a decentralized, parallel optimistic stochastic gradient (DPOSG) algorithm solves a class of non-convex, non-concave min/max functions with provable non-asymptotic convergence to a first-order stationary point. The DPOSG algorithm can comprise computer readable instructions stored on a computer readable medium. The DPOSG algorithm can be hosted on, applied to, or implemented by a computer or machine. In FIG. 2, each node comprises a physical computer or machine, or a virtual machine. The DPOSG algorithm can reside in the memory associated with a node, and can be executed by a processor associated with node.

Each of the nodes in FIG. 2 can be a node of a GAN implemented over a decentralized network topology. Specifically, each node can include the GAN weights (i.e., the local generator weights and discriminator weights of the node), in addition to the DPOSG algorithm, for training the GAN. The generator and the discriminator can be included in one or more nodes (not shown) coupled to the nodes illustrated in FIG. 2. As a non-limiting example, the generator can be included in the memory of a first node, the discriminator can be included in the memory of a second node, and the GAN weights can be included in the nodes of FIG. 2.

Each node generally includes a processor that obtains instructions and data via a bus from a memory or storage. Each node can is generally under the control of an operating system suitable to perform the functions described herein. The processor is a programmable logic device that performs instruction, logic, and mathematical processing, and may be representative of one or more CPUs. The processor may execute one or more applications in memory. The nodes may also include one or more network interfaces connected to the bus. The network interface may be any type of network communications device allowing the nodes to communicate with other nodes or computers via the network. The network interface may exchange data with the network.

The nodes can be connected to other nodes or computers via a network. The network comprises, for example, the Internet, a local area network, a wide area network, or a wireless network. The network can include any combination of physical transmission cables, optical transmission fibers, wireless transmission, routers, firewalls, switches, gateway computers and/or edge servers.

The memory or storage can be representative of hard-disk drives, solid state drives, flash memory devices, optical media, and the like. The memory or storage can also include structured storage, e.g. a database. In addition, the memory or storage may be considered to include memory physically located elsewhere; for example, on another computer coupled to the node via the bus or network.

The method 300 begins at block 302. At block 304, each node generates gradients based on its respective local weights. Node 202 includes generator weights 204, which the node 202 can use to generate gradients (not shown) that are used to update the generator weights 204. Likewise, node 202 includes discriminator weights 206, which the node 202 can use to generate gradients (not shown) that are used to update the discriminator weights 206. The gradients for the generator and discriminator can be calculated simultaneously in each node.

The generator weights and discriminator weights on each node are the weights associated with neurons of the GAN. These weights can be distributed among the nodes depending on available resources of the computing environment or network hosting the GAN. As a non-limiting example, node 202 can include the GAN weights from each neuron of the input layer of the generator and the discriminator. Node 212 can include the GAN weights from each neuron of a first hidden layer of the generator and the discriminator. Node 222 can include the GAN weights from each neuron of a second hidden layer of the generator and the discriminator. Node 232 can include the GAN weights from each neuron of a third hidden layer of the generator and the discriminator.

As previously mentioned, gradients are vectors of partial derivatives of a loss function with respect to the weight of each neuron. Therefore, returning to the previous example, the gradient calculated at each node includes the partial derivatives of the generator loss function and the discriminator loss function, or a composite min/max function, for each weight on the respective node.

Similarly, node 212 includes generator weights 214, which the node 212 can use to generate gradients that are used to update the generator weights 214. Likewise, node 212 includes discriminator weights 216, which the node 212 can use to generate gradients that are used to update the discriminator weights 216. Similarly, node 222 includes generator weights 224, which the node 222 can use to generate gradients that are used to update the generator weights 224. Likewise, node 222 includes discriminator weights 226, which the node 222 can use to generate gradients that are used to update the discriminator weights 226. Similarly, node 232 includes generator weights 234, which the node 232 can use to generate gradients that are used to update the generator weights 234. Likewise, node 232 includes discriminator weights 236, which the node 232 can use to generate gradients that are used to update the discriminator weights 236.

At block 306, each node exchanges its respective local weights (which includes both the generator and discriminator weights) with weights from a neighboring node. In one embodiment, each node performs a predetermined amount (T rounds) of weight exchanges with the neighboring node. As shown in FIG. 2, node 212 sends the generator weights 214 and discriminator weights 216 to node 202 and node 222. Node 212 also receives the generator weights 204 and discriminator weights 205 from node 202, and receives the generator weights 224 and discriminator weights 226 from node 222. Likewise, node 222 sends the generator weights 224 and discriminator weights 226 to node 212 and node 232. Node 222 also receives the generator weights 234 and discriminator weights 236 from node 232, and receives generator weights 214 and discriminator weights 216 from node 212.

Notable, in one embodiment, during each round, the nodes exchange weights with only their neighboring nodes. However, as the T rounds are completed, the generator and discriminator weights of a first node can reach an additional non-neighboring node. For example, assume the aforementioned weight exchanges of FIG. 2 occur during a first round of the T rounds. Upon completion of the first round, node 212 includes generator weights 206, generator weights 214, and generator weights 224. Node 222 includes generator weights 214, generator weights 224, and generator weights 234. During a second round of the T rounds, node 212 exchanges these generator weights with node 222. Hence, generator weight 234, which is local to node 232, reaches node 212, which is not a neighbor of node 232. In one embodiment, after T rounds of weight exchanges, each node can include the generator and discriminator weights of some, or all, of the nodes in the decentralized GAN. In the illustrated embodiment, after two rounds of weight exchanges, each node includes all of the weights on the nodes in the system 200. However, it is not necessary to perform an amount of T rounds such that each node includes all of the weights from the other nodes in order to converge on an optimized stationary point.

At block 308, each node can generate an average generator weight and discriminator weight based on the local weights and the weights from the neighboring node. For instance, after each round of the T rounds of weight exchanges, node 212 can average the local generator weights 214 with neighboring generator weights 204 and neighboring generator weights 224. Likewise, node 212 can average local discriminator weights 216 with neighboring discriminator weights 206 and neighboring discriminator weights 226 for each round of the T rounds. In one embodiment, averaging the local generator weights 204 and neighboring generator weights 224 can be executed in parallel with averaging the local discriminator weights 206 and neighboring discriminator weights 226. A count of the T rounds is iterated at the completion of block 308.

As previously mentioned, in one embodiment, after T rounds of weight exchanges, each node can include the weights of some, or all, of the nodes in the decentralized GAN. Therefore, the localized averaging at each node can guarantee convergence on a non-asymptotic first-order stationary point of a non-convex, non-concave min/max function when the amount of T rounds is large enough to approximate a full average, as would occur on a centralized network topology. Hence, the amount of T rounds can be selected such that the full average is approximated, despite each node calculating a localized average.

In some embodiments, the amount of T rounds can be set to relatively small number. For example, the amount of T rounds can range from 1-10 to achieve the full average. However, in some embodiments, the amount of T rounds can be set to a number greater than 10. A maximum amount of T rounds is limited only by computational constraints.

At block 310, if the T rounds of weight exchanges and averages have not been completed, the method 300 proceeds to block 306. At block 306, the local weights and neighboring weights are exchanged between nodes and averaged at each node, as described above. If the T rounds of weight exchanges and averages have been completed, the method 300 proceeds to block 312.

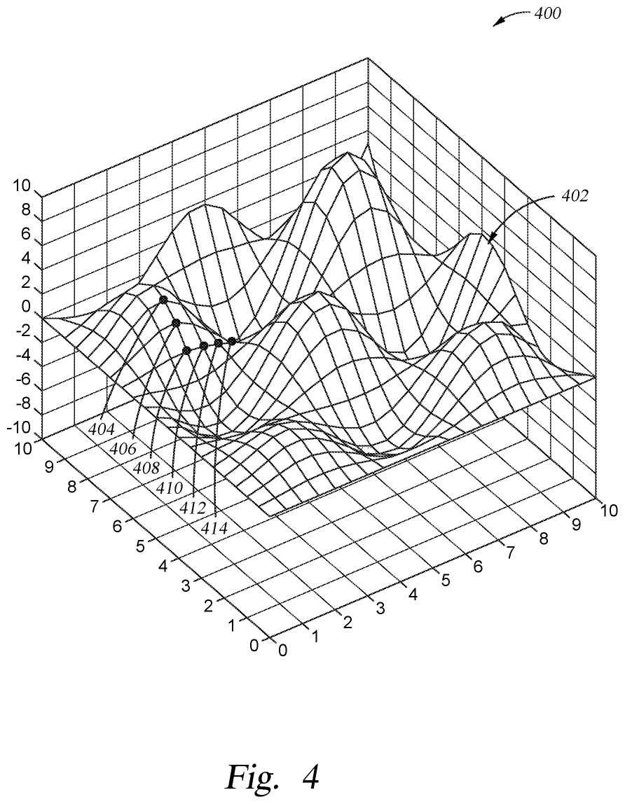

At block 312, each node updates its respective weights using a DPOSG algorithm. In one embodiment, the DPOSG algorithm can be implemented using a two-step process. In the first step of the process, a node updates its local weights using gradients generated in block 304 of a previous weight update iteration to adjust the average weight generated in block 308. In the second step of the process, the node further updates its local weights using the gradients generated in block 304 of the present weight update iteration to adjust the average weight generated in block 308. Each of the updates in the two step process move a proposed solution to the min/max function closer to the stationary point. Further, by implementing this two-step process for updating the GAN weights, the DPOSG algorithm can avoid getting trapped at a sub-optimal local min/max of a non-concave, non-convex min/max function. This process is described in further detail in FIG. 4.

At block 314, a validation input 108 is used to evaluate the GAN weights to determine the effects of the updates from block 312. In one embodiment, when the updates cause large changes to the weights, it is an indication that the weights are not yet optimized. That is, because a gradient is a partial derivative of a loss function, the gradient indicates a tangential slope of the loss function. A steeper slope indicates that an update is relatively distant from the stationary point. Thus, the updates to the weights cause large changes in the weights to make greater steps towards the stationary point. In comparison, a more horizontal slope indicates that the update is relatively close to the stationary point. Thus, the updates cause smaller changes in the weights to make a smaller steps towards the stationary point. Hence, when the updates cause insignificant changes to the weights, it is an indication that the system 200 has converged on a stationary point. In one embodiment, the stationary point comprises a saddle point or an equilibrium point at which the min/max function cannot be further minimized or maximized.

At block 316, if a termination condition is met, the method 300 proceeds to block 318, where the method 300 ends. In one embodiment, the termination condition is met after the DPOSG algorithm has been run for a predetermined number of weight update iterations. In another embodiment, the termination condition is met when the loss, or the error indicated by the loss function, is below a predetermined threshold. If the termination condition is not met, the method 300 proceeds to block 304, where the method 300 operates as previously discussed.

One benefit to the aforementioned system 200 and method 300 is an accelerated training of a GAN due to the training processes being divided among the nodes and executed in parallel. Another benefit to the aforementioned system 200 and method 300 is improved communication network traffic relative to neural networks implemented on a centralized network topology, since local gradients do not need to be sent to a central node. Another benefit to the aforementioned system 200 and method 300 is that large models and datasets can be stored in the memory of a single machine, which allows for the training of large neural networks.

FIG. 4 illustrates an iteration towards convergence on a stationary point for a non-convex, non-concave min/max function, according to one embodiment. As mentioned above, the DPOSG algorithm can evaluate potential changes caused by updates to the weights stored on a node both with respect to gradients based on GAN weights from the present weight update iteration and gradients based on GAN weights from a previous weight update iteration.

In one embodiment, the DPOSG algorithm can be implemented in a two-step process. The DPOSG algorithm can be applied to the generator 104, such that step 1 comprises updating a first set of local generator weights stored on a node (U_{LGW1}) as a function of a localized average generator weight (A_{GW}), a learning rate (L), and gradients based on generator weights from a previous weight update iteration (G_{GW_PREV}), such that U_{LGW1}=A_{GW}−L*G_{GW_PREV}. In one embodiment, G_{GW_PREV} is calculated using U_{LGW1} from the previous weight update iteration.

The DPOSG algorithm can be applied to the generator 104, such that step 2 comprises updating a second set of local generator weights stored on the node (U_{LGW2}) as a function of the localized average generator weight (A_{GW}), the learning rate (L), and gradients based on generator weights from the present weight update iteration (G_{GW_PRESENT}), such that U_{LGW2}=A_{GW}−L*G_{GW_PRESENT}. In one embodiment, U_{LGW1} and U_{LGW2} include the same generator weights prior to being updated. In one embodiment, G_{GW_PRESENT} is calculated using U_{LGW1} from the previous weight update iteration.

The DPOSG algorithm can be applied to the discriminator 110, such that step 1 comprises updating a first set of local discriminator weights stored on a node (U_{LDW1}) as a function of a localized average discriminator weight (A_{DW}), a learning rate (L), and gradients based on discriminator weights from a previous weight update iteration (G_{DW_PREV}), such that U_{LDW1}=A_{DW} L*G_{DW_PREV}. In one embodiment, G_{DW_PREV} is calculated using U_{LDW1} from the previous weight update iteration.

The DPOSG algorithm can be applied to the generator 104, such that step 2 comprises updating a second set of local discriminator weights stored on the node (U_{LDW2}) as a function of the localized average discriminator weight (A_{DW}), the learning rate (L), and gradients based on discriminator weights from the present weight update iteration (G_{DW_PRESENT}), such that U_{LDW2}=A_{DW}+L*G_{DW_PRESENT}. In one embodiment, U_{LDW1} and U_{LDW2} include the same discriminator weights prior to being updated. In one embodiment, G_{DW_PRESENT} is calculated using U_{LDW1} from the current weight update iteration.

In the illustrated embodiment, node 212 can use a DPOSG algorithm to update the generator weights 214 and discriminator weights 216. As a non-limiting example, assume that node 212 generates gradients (G_{GW_PREV}) to update the generator weights 214 during a first iteration. For step 1, during a second iteration, node 212 can generate an average (A_{GW}) of the local generator weights 214, neighboring generator weights 208, and neighboring generator weights 218 over T rounds. Node 212 can then adjust A_{GW} based on a learning rate applied to G_{GW_PREV}, where G_{GW_PREV} is the gradient calculated using the weights (U_{LGW1}) from the previous weight update iteration, and assign the adjustment as an update to the generator weights 214. Therefore, the generator weights 214 are updated using the localized average of generator weights and gradients from the previous iteration. This update is illustrated on the non-concave, non-convex min/max function 402 in FIG. 4. As shown, the update of step 1 moves a proposed solution of the min/max function from location 404 to location 406, which places the proposed solution closer to the stationary point 414.

For step 2, during a third iteration, node 212 can generate gradients (G_{GW_PRESENT}) based on the local generator weights 214. Node 212 can then adjust A_{GW} based on a learning rate applied to G_{GW_PRESENT}, where G_{GW_PRESENT} is the gradient calculated using the weights (U_{LGW1}) from the current weight update iteration, and assign the adjustment as an update to the generator weights 214. Therefore, the generator weights 214 are updated using the localized average of generator weights and gradients from the previous iteration. This update is illustrated on the non-concave, non-convex min/max function 402, where the update of step 2 moves the proposed solution of the min/max function from location 406 to location 408, which again places the proposed solution closer to the stationary point 414.

A similar process can be performed to update weights of the discriminator 110. Although, the updates for the generator and discriminator are illustrated as sequential processes, the updates for the generator and discriminator can be performed in parallel. Further, both step 1 and step 2, as applied to the generator or discriminator, can be performed in parallel.

Continuing the example, assume that node 212 generates gradients (G_{DW_PREV}) to update the discriminator weights 214 during the first iteration. For step 1, during the second iteration, node 212 can generate an average (ADO) of the local discriminator weights 216, neighboring discriminator weights 210, and neighboring discriminator weights 220 over T rounds. Node 212 can then adjust A_{DW} based on a learning rate applied to G_{DW_PREV}, where G_{DW_PREV} is the gradient calculated using the weights (U_{LGW1}) from the previous weight update iteration and assign the adjustment as an update to the discriminator weights 216. Therefore, the discriminator weights 216 are updated using the localized average of discriminator weights and gradients from the previous iteration. This update is illustrated on the non-concave, non-convex min/max function 402. As shown, the update of step 1 moves a proposed solution of the min/max function from location 408 to location 410, which places the proposed solution closer to the stationary point 414.

For step 2, during the third iteration, node 212 can generate gradients (G_{DW_PRESENT}) based on the local discriminator weights 216. Node 212 can then adjust A_{GW} based on a learning rate applied to G_{DW_PRESENT}, where G_{DW_PRESENT} is the gradient calculated using the weights (U_{LGW1}) from the current weight update iteration, and assign the adjustment as an update to the discriminator weights 216. Therefore, the discriminator weights 216 are updated using the localized average of discriminator weights and gradients from the previous iteration. This update is illustrated on the non-concave, non-convex min/max function 402. As shown, the update of step 2 moves the proposed solution of the min/max function from location 410 to location 412, which places the proposed solution closer to the stationary point 414.

The second and third iterations can be repeated to ensure that the proposed solution converges on the stationary point 414 of the min/max function. As previously mentioned, in one embodiment, the stationary point comprises a saddle point or an equilibrium point at which the min/max function cannot be further minimized or maximized. In the illustrated embodiment, the stationary point is not located at a global maximum or minimum of the min/max function, though it could be.

One benefit to implementing the DPOSG algorithm in a two-step process is that updates to local weights using previous gradients and present gradients, will sufficiently change the proposed solution to the min/max function such that the proposed solution does not get stuck at a local, non-optimized solution to the min/max function. Further, when the change to the proposed solution is insignificant, the system 200 has converged on a stationary point.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method comprising:
generating gradients based on a first set of weights associated with a first node of a neural network;
exchanging the first set of weights with a second set of weights associated with a second node;
generating an average weight based on the first set of weights and the second set of weights; and
updating the first set of weights and the second set of weights via a decentralized parallel optimistic stochastic gradient (DPOSG) algorithm based on the gradients and the average weight.

2. The method of claim 1, wherein exchanging the first set of weights with the second set of weights comprises a predetermined amount of exchanges.

3. The method of claim 2, wherein the predetermined amount of exchanges ranges from 2-10 exchanges.

4. The method of claim 2, wherein generating the average weight comprises calculating the average weight over the predetermined amount of exchanges.

5. The method of claim 1, wherein the DPOSG algorithm comprises:
a first step for updating the first set of weights and second set of weights based on gradients from a previous weight update iteration; and
a second step for updating the first set of weights and second set of weights based on gradients from a present weight update iteration.

6. The method of claim 5, wherein the first step comprises updating a first set of generator weights (U_{LGW1}) as a function of an average generator weight (A_{GW}), a learning rate (L), and gradients based on generator weights from a previous weight update iteration (G_{GW_PREV}), such that U_{LGW1}=A_{GW}+L*G_{GW_PREV}, wherein G_{GW_PREV} is determined based on U_{LGW1} from the previous weight update iteration.

7. The method of claim 5, wherein the second step comprises updating a second set of generator weights (U_{LGW2}) as a function of an average generator weight (A_{GW}), a learning rate (L), and gradients based on generator weights from a present weight update iteration (G_{GW_PRESENT}), such that U_{LGW2}=A_{GW}+L*G_{GW_PRESENT}, wherein G_{GW_PRESENT} is determined based on U_{LGW1} from the present weight update iteration.

8. The method of claim 5, wherein the first step comprises updating a first set of discriminator weights (U_{LDW1}) as a function of an average discriminator weight (A_{DW}), a learning rate (L), and gradients based on discriminator weights from a previous weight update iteration (G_{DW_PREV}), such that U_{LDW1}=A_{DW}+L*G_{DW_PREV}, wherein G_{DW_PREV} is determined based on U_{LDW1} from the previous weight update iteration.

9. The method of claim 5, wherein the second step comprises updating a second set of discriminator weights (U_{LDW2}) as a function of an average discriminator weight (A_{DW}), a learning rate (L), and gradients based on discriminator weights from a present weight update iteration (G_{DW_PRESENT}), such that U_{LDW2}=A_{DW}+L*G_{DW_PRESENT}, wherein G_{DW_PRESENT} is determined based on U_{LDW1} from the present weight update iteration.

10. A system, comprising:
a first node of a neural network; and
a second node coupled to the first node, wherein the first node is configured to:
generate gradients based on a first set of weights associated with the first node;
exchange the first set of weights with a second set of weights associated with the second node;
generate an average weight based on the first set of weights and the second set of weights; and
update the first set of weights and the second set of weights via a decentralized parallel optimistic stochastic gradient (DPOSG) algorithm based on the gradients and the average weight.

11. The system of claim 10, wherein the exchange of the first set of weights with the second set of weights comprises a predetermined amount of exchanges.

12. The system of claim 11, wherein the predetermined amount of exchanges ranges from 2-10 exchanges.

13. The system of claim 10, wherein the generation of the average weight comprises calculating the average weight over the predetermined amount of exchanges.

14. The system of claim 10, wherein the DPOSG algorithm comprises:
a first step for updating the first set of weights and second set of weights based on gradients from a previous weight update iteration; and
a second step for updating the first set of weights and second set of weights based on gradients from a present weight update iteration.

15. The system of claim 14, wherein the first step comprises updating a first set of generator weights (U_{LGW1}) as a function of an average generator weight (A_{GW}), a learning rate (L), and gradients based on generator weights from a previous weight update iteration (G_{GW_PREV}), such that U_{LGW1}=A_{GW}+L*G_{GW_PREV}, wherein G_{GW_PREV} is determined based on U_{LGW1} from the previous weight update iteration.

16. The system of claim 14, wherein the second step comprises updating a second set of generator weights (U_{LGW2}) as a function of an average generator weight (A_{GW}), a learning rate (L), and gradients based on generator weights from a present weight update iteration (G_{GW_PRESENT}), such that U_{LGW2}=A_{GW}+L*G_{GW_PRESENT}, wherein G_{GW_PRESENT} is determined based on U_{LGW1} from the present weight update iteration.

17. The system of claim 14, wherein the first step comprises updating a first set of discriminator weights (U_{LDW1}) as a function of an average discriminator weight (A_{DW}), a learning rate (L), and gradients based on discriminator weights from a previous weight update iteration (G_{DW_PREV}), such that U_{LDW1}=A_{DW}+L*G_{DW_PREV}, wherein G_{DW_PREV} is determined based on U_{LDW1} from the previous weight update iteration.

18. The system of claim 14, wherein the second step comprises updating a second set of discriminator weights (U_{LDW2}) as a function of an average discriminator weight (A_{DW}), a learning rate (L), and gradients based on discriminator weights from a present weight update iteration (G_{DW_PRESENT}), such that U_{LDW2}=A_{DW}+L*G_{DW_PRESENT}, wherein G_{DW_PRESENT} is determined based on U_{LDW1} from the present weight update iteration.

19. A computer-readable storage medium including computer program code that, when executed on one or more computer processors, performs an operation configured to:
generate gradients based on a first set of weights associated with a first node of the neural network;
exchange the first set of weights with a second set of weights associated with a second node;
generate an average weight based on the first set of weights and the second set of weights; and
update the first set of weights and the second set of weights via a decentralized parallel optimistic stochastic gradient (DPOSG) algorithm based on the gradients and the average weight.

20. The computer program product of claim 19, wherein the exchange of the first set of weights with the second set of weights comprises a predetermined amount of exchanges,
wherein the generation of the average weight comprises calculating the average weight over the predetermined amount of exchanges, and wherein the DPOSG algorithm comprises:
a first step for updating the first set of weights and second set of weights based on gradients from a previous weight update iteration; and
a second step for updating the first set of weights and second set of weights based on gradients from a present weight update iteration.
